(19) United States
(12) Patent Application Publication
(10) Pub. No.: US 2010/0312638 A1
(43) Pub. Date: Dec. 9, 2010

(54) INTERNET-BASED ADVERTISEMENT MANAGEMENT

(75) Inventors: Kamal Jain, Bellevue, WA (US); Alexander Cowles White, Toulouse (FR)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 12/479,927

(22) Filed: Jun. 8, 2009

(51) Int. Cl. G06Q 10/00; G06Q 30/00; G06F 17/30

(52) U.S. Cl. 705/14.43; 705/14.41; 705/14.45; 705/14.46; 707/E17.017; 707/E17.044

(57) ABSTRACT

Techniques and systems are disclosed where a user utility for Internet-based advertising can be measured for a combination of a search-based website (SBS) and one or more content-based web-sites (CBSs). Determining user utility for web-based economics can comprise determining a user benefit metric for a combination of a SBS and one or more CBSs, where the user benefit metric may be a combination of a SBS user experience metric and a CBS user experience metric. A user cost metric can be determined by combining a SBS cost metric with a CBS cost metric. The user benefit metric can be combined with the user cost metric to determine the user utility for a combination of SBS and one or more CBSs.

### BACKGROUND

The Internet is often used to find content of particular interest to users, such as relevant news articles, research topics, videos, and other content. When a user searches for content (e.g., they do not know an exact location for the desired content) they typically utilize we-based search engines, situated on search-based websites. Search engines index web-content and return results, such as links to content-based websites, to users based on a query posed by a user. The search engine services are typically provided at no monetary cost to users; search-based sites typically generate revenue by placing advertising on the site, which is a significant source of revenue for the Internet-based economy. Further, the content-based websites linked from the search engine results can also display advertisement to generate revenue for providing content for no monetary cost to users.

### SUMMARY

This Summary is provided to introduce a selection of concepts in a simplified form that are further described below in the Detailed Description. This Summary is not intended to identify key factors or essential features of the claimed subject matter, nor is it intended to be used to limit the scope of the claimed subject matter.

Internet users often navigate from a search-based website (SBS) to one or more content-based websites (CBSs), by utilizing links returned from a query to a search engine on the SBS. Further, both the SBS and the CBS typically generate revenue by displaying advertisements to the user. The methods used by the SBS and CBS to determine the advertisements to display may differ. For example, SBSs typically display advertisements based on keywords from the user's query, such as showing ads for car dealers when the user queries for a type of automobile. Therefore, SBSs can determine ads to display based on the user's intent (e.g., a real-time interest in something they may wish to purchase). On the other hand, the CBSs have particular content on their sites, and advertisements can be displayed based on the content of the website. Therefore, CBSs can determine ads to display based on the user's interest (e.g., interested in particular content).

Further, SBS ads are typically more subtle and text-based, where determinations for which ads to show are based on keywords from the query, and the advertisers are charged on a per-click basis. In contrast, most prominent and profitable advertising on a CBS is typically “display” advertising, which can comprise flashy banners, animations and sounds that pop out to the users from the page. This type of advertising can be sold through various channels, including, direct negotiations and third-party ad matching services. Display advertising is often sold on a per-impression (e.g., each time seen by user) basis.

The SBS and CBS can act as complements of each other, where the user gets to the CBS by searching and the SBS is only used to find content, so that one may not be effective without the other. However, the combination of a SBS and CBS do not typically coordinate their advertising, so a user may find themselves overwhelmed by an amount and/or type of advertising to a point where they are overly distracted. Users may find the level of advertising (e.g., a cost to the user) on the combined sites distasteful and choose to patronize either another SBS and/or another CBS when weighed against the content (e.g., benefit to user). The SBS/CBS combination may be able to reach a desired level of revenue for their advertising (e.g., optimizing the revenue) by creating a combined advertising level that reaches a desired level of utility, where a user is not overly distracted so they still use the sites.

Techniques and systems are disclosed where a user utility can be measured for a combination of a SBS and one or more CBSs. The user utility may be utilized to determine a level of advertising (e.g., a type and amount) that is appropriate to maintain a desired level of revenue, for example. Further, the level of advertisement can be manipulated on either the SBS and/or the CBS in order to achieve the desired user utility. Additionally, a SBS may choose to rank CBSs, having a similar content score, based on the user utility for the combination of the SBS and the various CBSs returned as results to a query.

In one embodiment, determining user utility for web-based economics can comprise determining a user benefit metric for a combination of a SBS and one or more CBSs. The user benefit metric can be a combination of a SBS user experience metric (e.g., based on relevant results returned for a query) and a CBS user experience metric (e.g., based on relevant content on the CBS). A user cost metric for the SBS/CBS combination can be determined by combining a SBS cost metric (e.g., a cost to a user based on a type and amount of advertising on the site) with a CBS cost metric. Further, the user benefit metric can be combined with the user cost metric (e.g., by subtracting the cost from the benefit) to determine the user utility for a combination of SBS and one or more CBSs.

To the accomplishment of the foregoing and related ends, the following description and annexed drawings set forth certain illustrative aspects and implementations. These are indicative of but a few of the various ways in which one or more aspects may be employed. Other aspects, advantages, and novel features of the disclosure will become apparent from the following detailed description when considered in conjunction with the annexed drawings.

### DESCRIPTION OF THE DRAWINGS

FIG. 1 is an illustration of an exemplary environment where one or more techniques and/or systems describe herein may be implemented.

FIG. 2 is a flow chart diagram of an exemplary method for determining user utility for web-based economics.

FIG. 3 is a flow chart diagram of one embodiment of a method for determining user utility for web-based economics.

FIG. 4 is a flow chart of an exemplary embodiment, where a user utility is determined for a combination of a search-based website and a content-based website.

FIG. 5 is a flow chart diagram of an exemplary embodiment, where characteristics of a user utility may be measured and adjusted in order to produce a desired user utility for a combination of a search-based website and one or more content-based websites.

FIG. 6 is an illustration of one embodiment of an environment where a user utility may be utilized.

FIG. 7 is a component block diagram of an exemplary system for determining user utility for a combination of a search-based website and one or more content-based websites, for web-based economics.

FIG. 8 is a component block diagram of one exemplary embodiment of a portion of a system where inputs to an exemplary system can be determined.

FIG. 9 is an illustration of an exemplary computer-readable medium comprising processor-executable instructions configured to embody one or more of the provisions set forth herein.

FIG. 10 illustrates an exemplary computing environment wherein one or more of the provisions set forth herein may be implemented.

### DETAILED DESCRIPTION

The claimed subject matter is now described with reference to the drawings, wherein like reference numerals are used to refer to like elements throughout. In the following description, for purposes of explanation, numerous specific details are set forth in order to provide a thorough understanding of the claimed subject matter. It may be evident, however, that the claimed subject matter may be practiced without these specific details. In other instances, structures and devices are shown in block diagram form in order to facilitate describing the claimed subject matter.

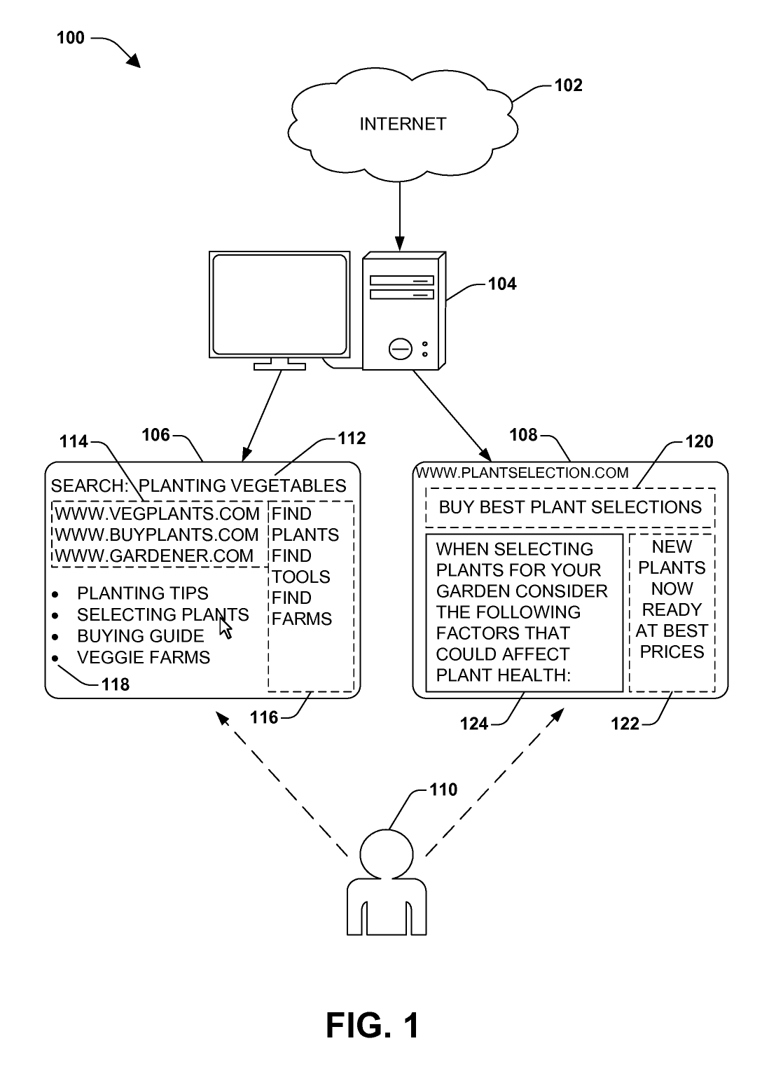

FIG. 1 is an illustration of an exemplary environment 100 where one or more of the techniques and/or systems describe herein may be implemented. A user 110 may wish to connect to the Internet 102 using their personal computer 104, for example, in order to find specific content. Unless the user 110 knows, for example, and can specify to their web browser an address for a website they wish to visit, they typically utilize a search-based site 106 (SBS), that utilizes a search engine to find the user's desired content.

When the user 110 navigates to the SBS 106 and enters their search query 112, they are often confronted with one or more types of advertisements 114 and 116, along with retrieved results 118 for their query 112. As an example, web-retailers may buy ad-space on the SBS based on keywords from the user's query 112. In this example, the query “planting vegetables” elicits ads from sites that may sell plants 114, and sites that may help the user find other things related to plants 116. Further, the search engine returns relevant search results 118 for the query 112 that may lead to content-based sites (CBS) that have relevant content for the user's desired task.

In this exemplary environment 100, the user selects “selecting plants,” for example, by clicking on the link in the results 118 from the SBS 106. By selecting the link, the user 110 can be directed to the CBS 108 for that link. The CBS 108 can also have advertisements 120 and 122, which are often related to the subject covered by the content 124 of the CBS 108, in this example, plant selection for gardens. In this example, the advertisements offer plants for the user 110 to purchase, based on their interest in plant selection; while the CBS 108 also offers content 124 related to plant selection for a garden.

A method may be devised that allows for management of an amount and type of advertisement shown to a user, for example, when a user utilizes a search-based website to access a content-based website. The method can provide a way to measure likely user responses to a varying combined amount and type of advertisements shown to a user on the combined search and content websites, for example, in order to provide economic utility for both the search-based websites and content-based websites.

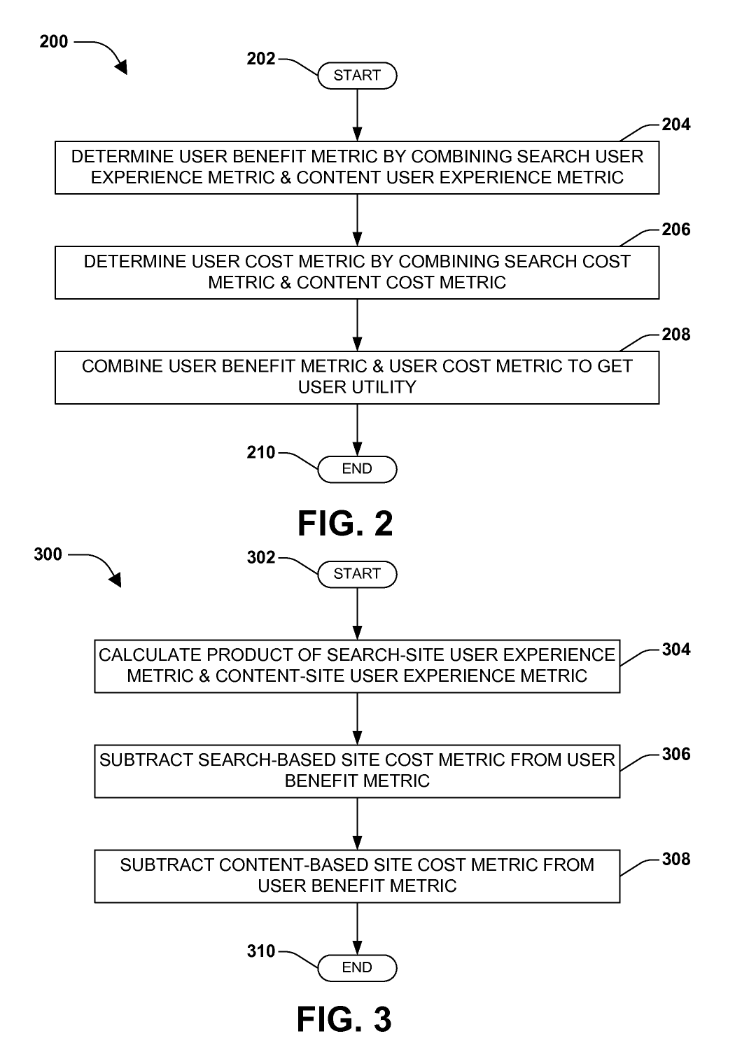

FIG. 2 is a flow chart diagram of an exemplary method 200 for determining user utility for web-based economics. The exemplary method 200 can be executed via a processor on a computer comprising a memory whereon computer-executable instructions comprising the method are stored. The exemplary method 200 begins at 202 and involves determining a user benefit metric, which comprises combining a search-based site (SBS) user experience metric and a content-based site (CBS) user experience metric, at 204.

For example, the user benefit metric can measure a combined user experience when visiting the SBS and one or more CBSs to which the user navigated from the SBS. In one embodiment, the user experience metric may comprise measuring whether the user found what they were looking for, and measuring how much of what they were looking for was found on the site. In one embodiment, the SBS user experience metric may be based on a relevance of returned results to a query on the SBS. In one embodiment, the CBS user experience metric may be based on relevance of content on the CBS directed to from the SBS.

At 206, in the exemplary method 200, a user cost metric is determined, which comprises combining a SBS cost metric with a CBS cost metric. For example, the user cost metric can be a combined measure of a cost to the user associated with visiting the SBS and one or more CBSs to which the user navigated from the SBS. In one embodiment, a measure of a cost to the user may comprise an amount and type of advertisement shown to the user while visiting the sites. For example, a greater amount of advertisement can be more distracting to the user, and may diminish an amount of content shown to the user. Further, in this example, ads that are flashier (e.g., larger, brighter, involve movement, hover, mask content, enlarge, follow users viewing pane, produce sound, etc.) can also be more distracting to a user. In this example, an increase in distraction and/or less content can comprise a greater cost to the user for visiting these sites.

At 208, in the exemplary method 200, the user benefit metric is combined with the user cost metric to determine the user utility for a combination of the SBS and one or more CBSs. In one embodiment, the user cost metric can be weighed against the user benefit metric to obtain the user utility. For example, consumers (e.g., users of the Internet) may make choices on using or purchasing products by weighing the benefits that may accrue to them versus the cost of purchasing the product. In this example, if the costs outweigh the benefits, the consumer typically won't make the purchase. In one embodiment, if the user perceives too much cost, in the form of distraction, for the perceived benefit, in the form of relevant content, they may not visit the SBS and/or the CBS.

Having determined the user utility for the combination of the SBS and the one or more CBSs, the exemplary method 200 ends at 210.

FIG. 3 is a flow chart diagram of one embodiment 300 of the method described above. The exemplary embodiment 300 of the method begins at 302, and involves multiplying the SBS user experience metric by the CBS user experience metric, to determine the user benefit metric, at 304. In this way, for example, the user benefit metric may have a larger role in determining the user utility, and may mitigate negative user utility values.

At 306, the SBS cost metric is subtracted from the user benefit metric to produce a result, and the CBS cost metric is subtracted from the result, at 308. As described above, the cost metrics can be used to diminish the user experience metric, for example, as user distraction diminishes the users experience on a website, to determine the user utility for the combination of the SBS and the one or more CBSs to which the user is directed from the website. In one embodiment, if the user merely visits the SBS and not the CBS, merely the SBS cost metric is subtracted from the user benefit metric to produce the utility metric.

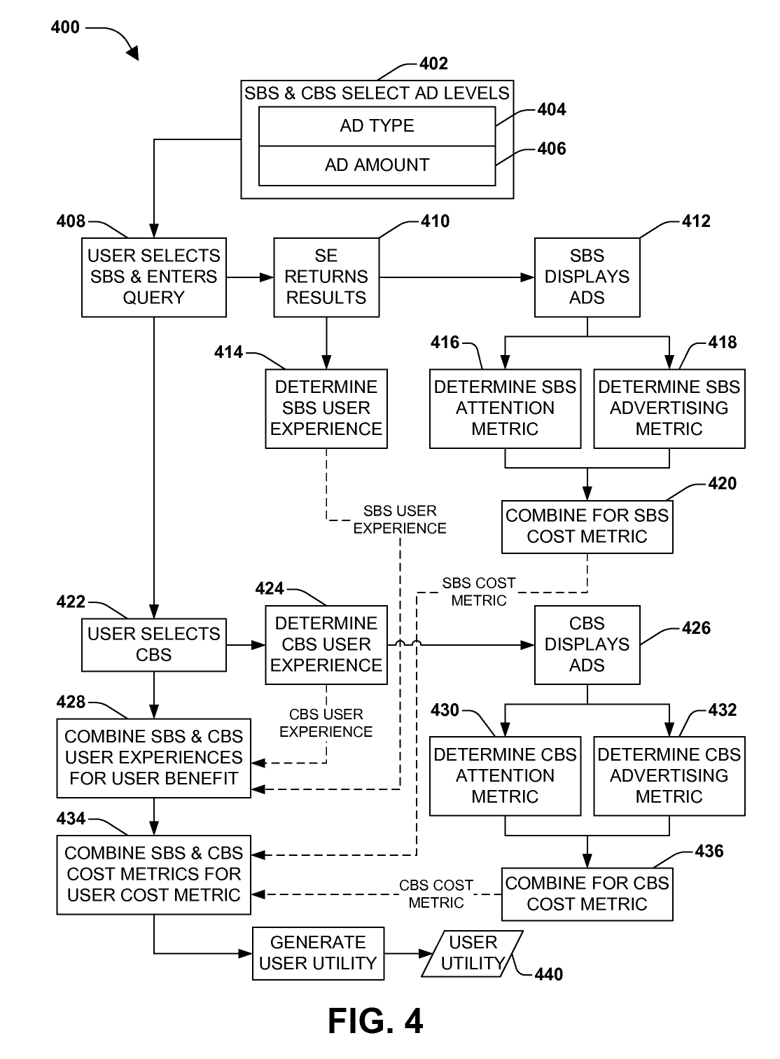

FIG. 4 is a flow chart of an exemplary embodiment 400, where a user utility is determined for a combination of a SBS and a CBS. At 402, both the SBS and CBS select their advertising levels, which can comprise an advertisement type 404 (e.g., size, location on the page, text-based, graphical, moving, etc.) and an advertising amount 406 (e.g., how many ads per page). At 408, a user selects a SBS, for example, to find websites having particular content, and enters their query into a search engine on the SBS.

At 410, the SBS returns results relevant to the query, and displays advertisements relative to the query and in accordance with their selected advertisement level, at 412. Based on the returned results, an SBS user experience metric can be determined, at 414, for example, based on an amount and level of relevance to the query, for the results.

At 416, a user attention metric can be determined for the ad levels selected by the SBS, and shown to the user. In one embodiment, determining a user attention metric may comprise determining how much the user is distracted by the amount and type of advertisements associated with the SBS ad levels. For example, large flashy ads are typically more distracting than small text-based ads. At 418, an advertising metric can be determined for the ad levels selected by the SBS, and shown to the user.

In one embodiment, the advertising metric may be determined based on a desired amount of revenue generated per user for an amount of user attention called for the advertising characteristics, for example, where the advertising characteristics comprise the types 404 and amounts 406 of ads shown to the user by the SBS. In one embodiment, the advertising metric can be adjusted for the SBS to obtain a desired user utility for the combination of the SBS and the one or more CBSs. For example, where a combined amount of advertising on the SBS and CBSs has a negative effect on the user utility, the SBS may want to adjust their advertising metric (e.g., by adjusting the type and/or amount of ads) in order to yield a better utility score.

At 420, in the exemplary method 400, the SBS attention metric and SBS advertising metric can be combined to produce the SBS cost metric. In one embodiment, the SBS attention metric may be a function of the SBS advertising metric, and the SBS cost metric may be a function of both, such as: dₛ(aₛ); where dₛ represents the distraction or attention caused by the advertising on the SBS, and aₛ represents the advertising levels chosen by the SBS, leading to a combined SBS cost metric, cₛ(dₛ(aₛ),aₛ).

At 422, the user may select a CBS, for example, from the results returned by the SBS. At 424, the CBS user experience can be determined, for example, based on an amount and type of relevant content displayed by the CBS. At 426, the CBS displays the ads on their page, for example, in accordance with the ad levels selected by the CBS. At 430, the CBS attention metric can be determined, and the CBS advertising metric can be determined at 432, such as described above for the SBS. The CBS attention metric and the CBS advertising metric are combined at 436, such as described above for the SBS.

In one embodiment, the advertising metric on the CBS can be adjusted to obtain a desired user utility for the combination of the SBS and the CBS. As described above for the SBS, the CBS's advertising metric can be adjusted, for example, to accommodate an ad level found on the SBS in order to achieve a desired user utility level. Further, the advertising metric on a first CBS can be adjusted to obtain a desired user utility for a combination of the SBS and one or more second CBSs. For example, where the results from a query yield more than one CBS in the results, a user may choose to visit more than merely one CBS. In this example, the advertising metric can be adjusted (e.g., by adjusting the ad type and/or amount) for one of the CBSs in the result to accommodate ad levels on the other CBSs and/or the SBS, in order to achieve a desired user utility.

At 438, in the exemplary embodiment 400, the SBS user experience and the CBS user experience can be combined (e.g., multiplied) to determine the user benefit metric, for example, where the user visits both the SBS and the CBS. Further, at 434, the cost metrics for the SBS and CBS are combined to determine the user cost metric. At 438, the user experience metric and user cost metric are combined for the SBS and CBS to generate a user utility 440 for the combination of the SBS and CBS.

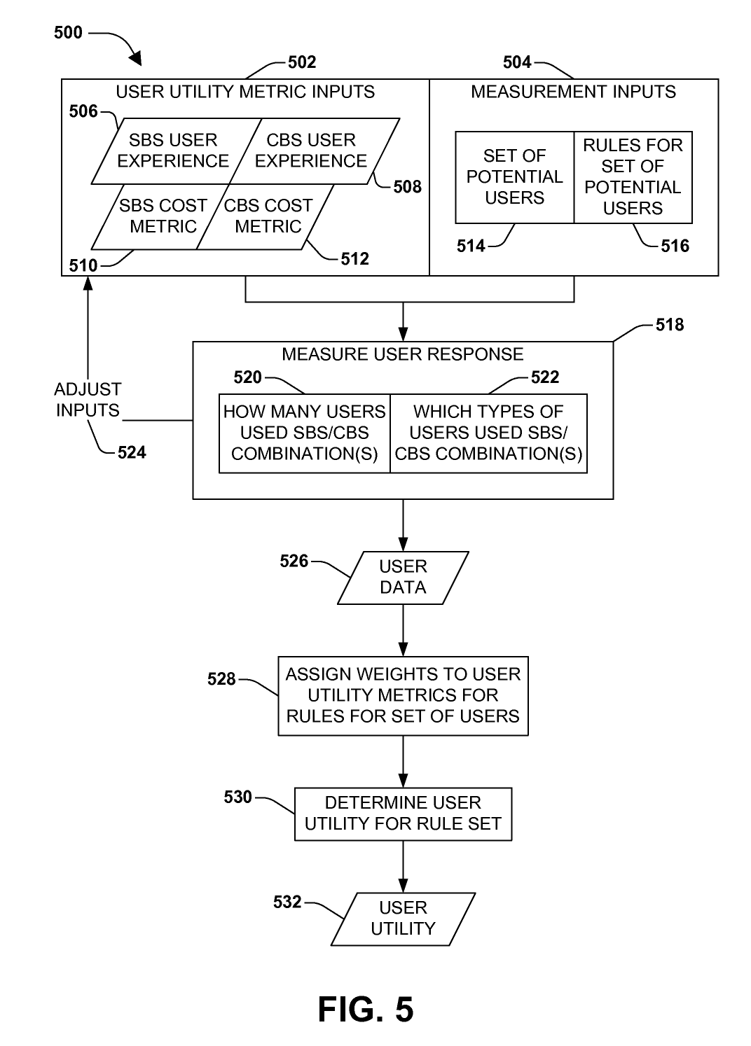

FIG. 5 is a flow chart diagram of an exemplary embodiment 500, where characteristics of the user utility may be measured and adjusted in order to produce a desired user utility for the combination of a SBS and one or more CBSs. User utility metric inputs 502 can comprise the SBS user experience metric 506, CBS user experience metric 508, SBS user cost metric 510, and the CBS user cost metric 512. Further, for example, if one wished to measure an effect that varying the values of the utility metric inputs 502 had upon a set of potential users 514, measurement inputs can be utilized, comprising the set of potential users 514 of the combined SBS and one or more CBSs, and a rule set for the potential users 516.

In one embodiment, for different users there may be different rule sets (or functions) that describe how a set of users reacts to the combination of the SBS and one or more CBSs. Users utilize search engines and/or content-based websites for different reasons. For example, some user merely use search engines to see what they can find for a particular query, and may not be actually interested in navigating to a content-based website, or may not know what they want and use the search engine to narrow their search. Therefore, in this example, a system administrator may utilize knowledge about various rule sets for potential users to apply particular user utility levels that provide a desired amount of revenue.

For example, an administrator of a SBS that utilizes the user utility to adjust advertising metrics for the combined sites may wish to measure administrative benefits and costs associated with using various user utility metric inputs 502. In one embodiment, the administrator may adjust combinations of values for the various user utility metric inputs 502, for example, by adjust advertisement metrics and measure an effect on users, in order to produce a desired user utility.

In one embodiment, in order to measure an effect on users when an adjustment is made to user benefit metrics and/or user cost metrics, the weight of the user utility metric inputs can be measured. A level can be set for one or more of the respective metrics used as user utility metric inputs 502. At 514, in the exemplary embodiment 500, user response to the settings of the user utility metric inputs 502 can be observed, from the set of potential users 514. At 520, how many users use the combination of the SBS and one or more CBSs can be observed, and which types of users utilize the combination, at 522. The inputs can be adjusted, at 524, and another set of user measurements can be determined.

The user-based data 526, obtained by measuring the user response, can be used to assign weights to the user utility metrics 502 for the rules 516 of the set of potential users 514. In one embodiment, experimenting with and varying the inputs 502 (e.g., characteristics of the user utility), and observing the user effect, for example, may enable system administrators to quantify a relative contribution of the various inputs 502, with respect to each other. Further, at 530, a user utility 532 can be determined for the rule set 516 and/or the set of potential users 514.

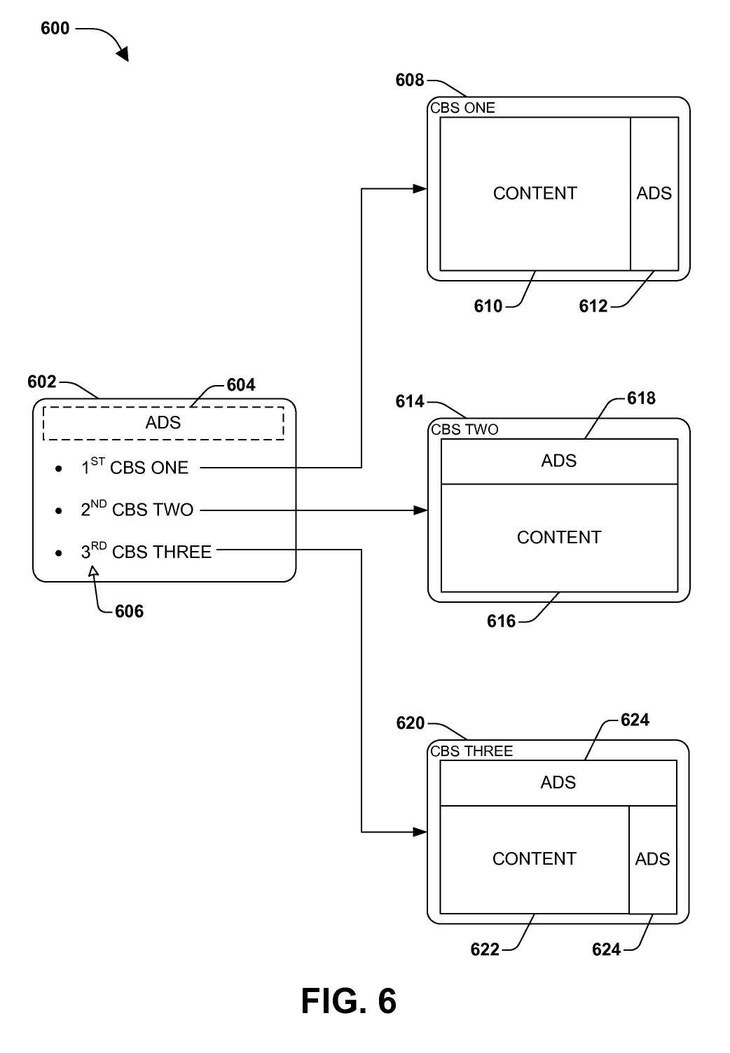

In one aspect, the user utility may be used by a search-based site (SBS) to improve the user experience. In one embodiment, after a user poses a query to the search engine, the SBS can adjust an ordering of one or more content-based websites (CBSs) on the SBS's display page based on the user utility for the respective content-based websites CBSs in combination with the SBS. In this embodiment, using techniques such as those described in FIG. 4, for example, the combination of the SBS with one or more CBSs can create an overall SBC/CBS user cost metric for this combination of sites. FIG. 6 is an illustration of one embodiment of an environment 600 where the user utility may be utilized.

In the exemplary environment 600, a SBS displays a query results page 602 comprising SBS advertisements 604 and search results 606. In one embodiment, the SBS may wish to maintain a desired user utility, for example, in order to keep users and attract new users to its search engine so that advertising revenues may be maintained. In this embodiment, the desired user utility may reflect a certain level of advertising (e.g., comprising type and amount) on the SBS combined with one or more CBSs. However, one or more of the CBSs may maintain a level of advertising that negatively affects the user utility, for example, by having too many ads or ads that are very distracting. In the exemplary embodiment 600, the SBS can rank CBSs 606, which may have similar relevance scores for their content, based on their utility score when combined with the SBS.

In this way, a SBS can attempt to maintain their desired utility score by directing users to a CBS that has an appropriate advertising level (e.g., cost) and content (e.g., experience), to facilitate the desired utility score. In the exemplary embodiment 600, CBS one is ranked first, as their page 608 displays a few ads 612 and appropriate content 610. CBS two ranks second, for example, as their ads 618 on their display 614 may expand from the top to cover the content 616, creating a greater distraction. CBS three ranks third, as their display 620 has multiple ads 624, limiting the content 622 and further distracting the user.

In another aspect, the user utility may be utilized to help manage revenues for respective search-based sites and content-based sites, for example, by maintaining a particular number and type of users that interact with the sites and their ads. In one embodiment, a desired user utility may provide a desired amount of user interaction with the combination of SBS and one or more CBSs, for example, whereby ad revenue can be generated for both types of sites. For example, if one of the sites in the SBS/CBS combination comprises too many ads or too much distraction for users, the users may no longer utilize that site for either their searching and/or their content-based information.

In one embodiment, when a user utility is outside of a desired range (e.g., a range that produces a desired amount of revenue for the sites) it may be advantageous for either the SBS or CBS to adjust their advertising level in order to bring the user utility within range. For example, while a SBS may maintain an ad level that maintains a desired user utility, a CBS may set an ad level that decreases the user utility for the SBS/CBS combination. In this example, even though the SBS had an appropriate ad level for a different SBS/CBS combination, it may wish to reduce its ad level (e.g., either the amount or type of ads) in order to bring the user utility within a desired range. Even though the ads on the SBS were not outside of a range that may decrease user interaction, the combination with the CBS having a higher ad level may reduce user interaction for the combination, thereby reducing potential ad revenue for the SBS.

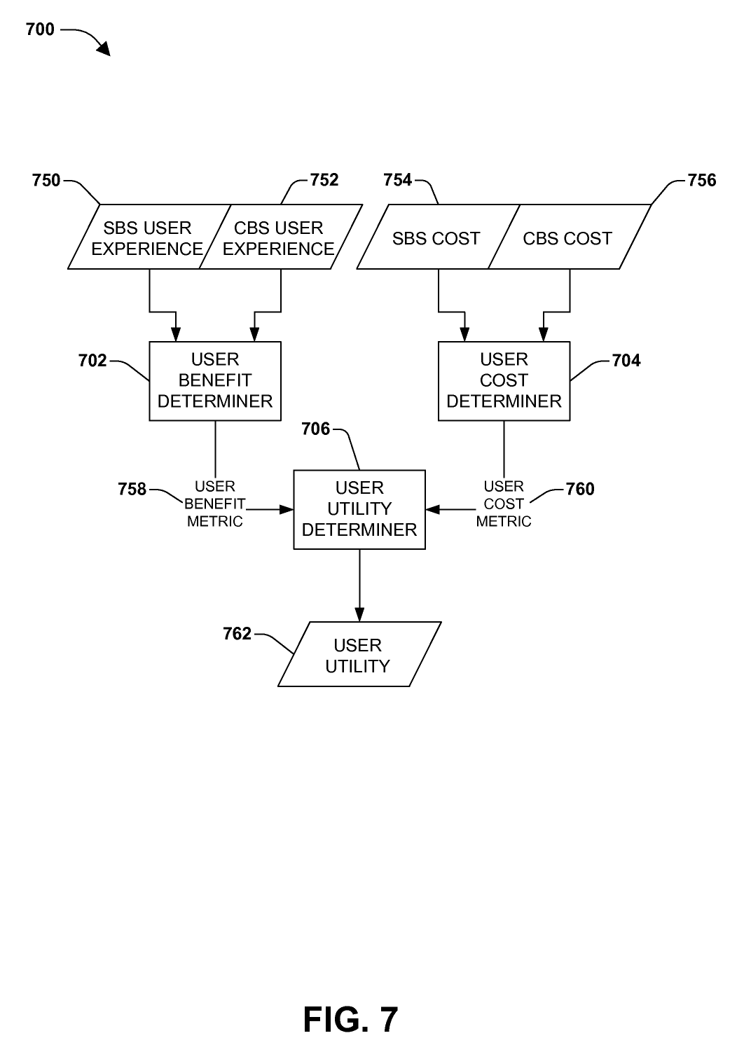

A system may be devised that allows for management of an amount and type of advertisement shown to a user, for example, when a user utilizes a search-based website to access a content-based website. FIG. 7 is a component block diagram of an exemplary system 700 for determining user utility for a combination of a search-based website and one or more content-based websites, for web-based economics.

A user benefit determination component 702 combines a search-based site (SBS) user experience metric 750 and a content-based site (CBS) user experience metric 752 to generate a user benefit metric 758. Further, a user cost determination component 704 combines a SBS cost metric 754 with a CBS cost metric 756 to generate a user cost metric 760. Additionally, a user utility determination component 706 combines the user benefit metric 758 with the user cost metric 760 to generate a user utility metric 762 for the combination of the SBS and the one or more CBSs.

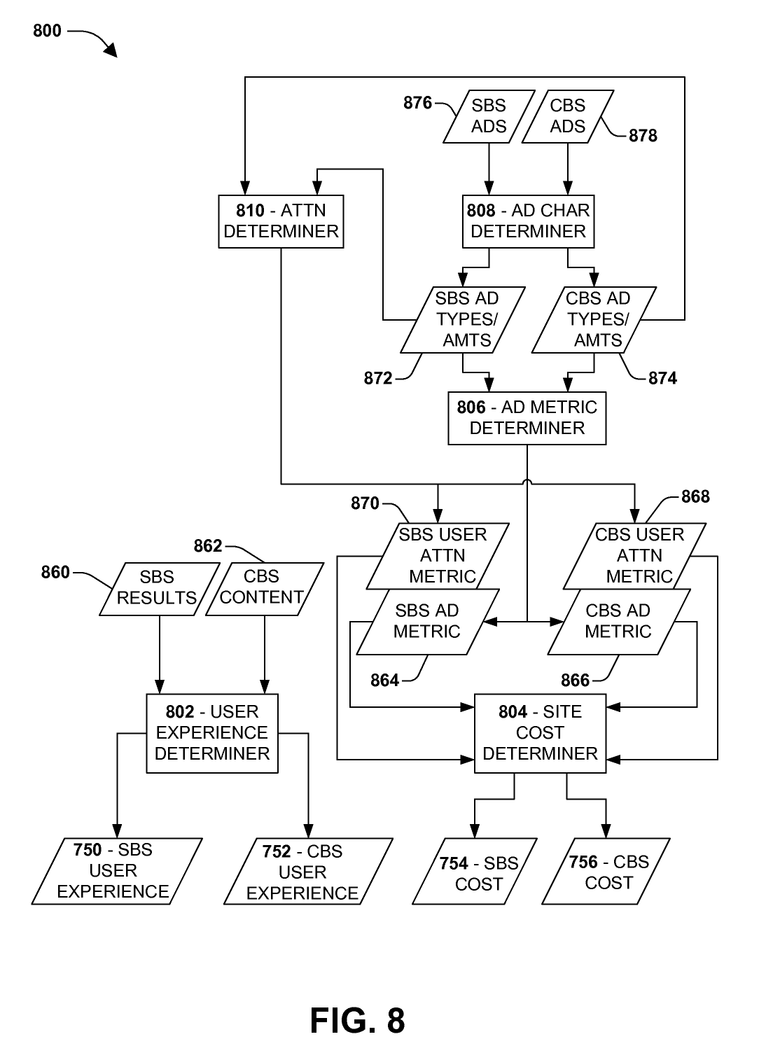

FIG. 8 is a component block diagram of one exemplary embodiment 800 of a portion of a system where the inputs to the exemplary system 700 can be determined. A user experience determination component 802 determines the SBS user experience metric 750 based on relevance of returned results 860 to a query on a SBS, and determines the CBS user experience metric 752 based on relevance of content 862 on a CBS, for example, to which a user was directed from the SBS.

An advertising characteristics determination component 808 determines an advertising characteristics metric 872 for the SBS by combining an advertising type (e.g., based on size and amount of potential user distraction) metric and an advertising amount (e.g., how many ads) metric for the search-based website, which are based on ads shown on the SBS 876. Further, the advertising characteristics determination component 808 determines an advertising characteristics metric 874 for the CBS by combining an advertising type metric and an advertising amount metric for the content-based website, based on the ads shown on the CBS 878.

An advertising metric determination component 806 determines an advertising metric 806, for the both the SBS 864 and CBS 866, which is based on desired amount of revenue generated per user for an amount of user attention called for a measure of advertising characteristics on a web-page. In one embodiment, the ad metric can be adjusted by adjusting the types and/or amounts of ads 876 and 878.

A user attention determination component 810 determines a user attention metric 870 for the SBS by determining how much a user may be distracted by the types and amounts of advertising 872 on the SBS. Further, the user attention determination component 810 determines a user attention metric 868 for the CBS by determining how much a user can be distracted by the types and amounts of advertising 874 on the CBS. The SBS advertising metric 864 can be combined with a SBS user attention metric 870 by a site cost determination component 804 to generate the SBS cost metric 754. Additionally, the cost determination component 804 can combine the CBS advertising metric 866 with the CBS user attention metric 868 to generate the CBS cost metric 756.

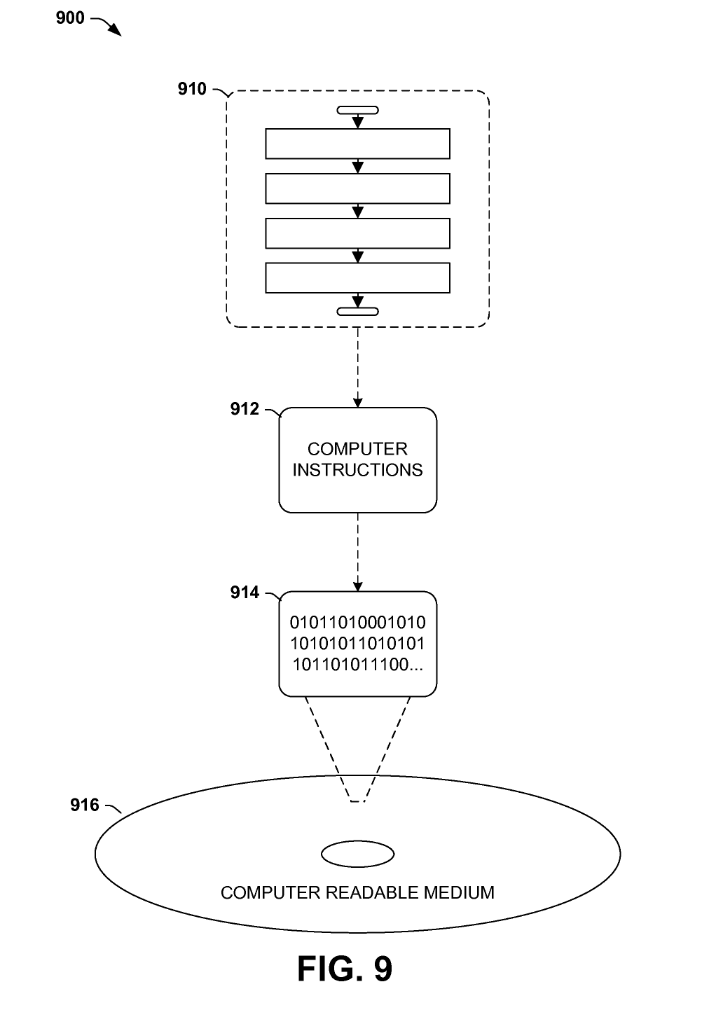

Still another embodiment involves a computer-readable medium comprising processor-executable instructions configured to implement one or more of the techniques presented herein. An exemplary computer-readable medium that may be devised in these ways is illustrated in FIG. 9, wherein the implementation 900 comprises a computer-readable medium 908 (e.g., a CD-R, DVD-R, or a platter of a hard disk drive), on which is encoded computer-readable data 906. This computer-readable data 906 in turn comprises a set of computer instructions 904 configured to operate according to one or more of the principles set forth herein. In one such embodiment 902, the processor-executable instructions 904 may be configured to perform a method, such as the exemplary method 200 of FIG. 2, for example. In another such embodiment, the processor-executable instructions 904 may be configured to implement a system, such as the exemplary system 700 of FIG. 7, for example. Many such computer-readable media may be devised by those of ordinary skill in the art that are configured to operate in accordance with the techniques presented herein.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

As used in this application, the terms “component,” “module,” “system”, “interface”, and the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, those skilled in the art will recognize many modifications may be made to this configuration without departing from the scope or spirit of the claimed subject matter.

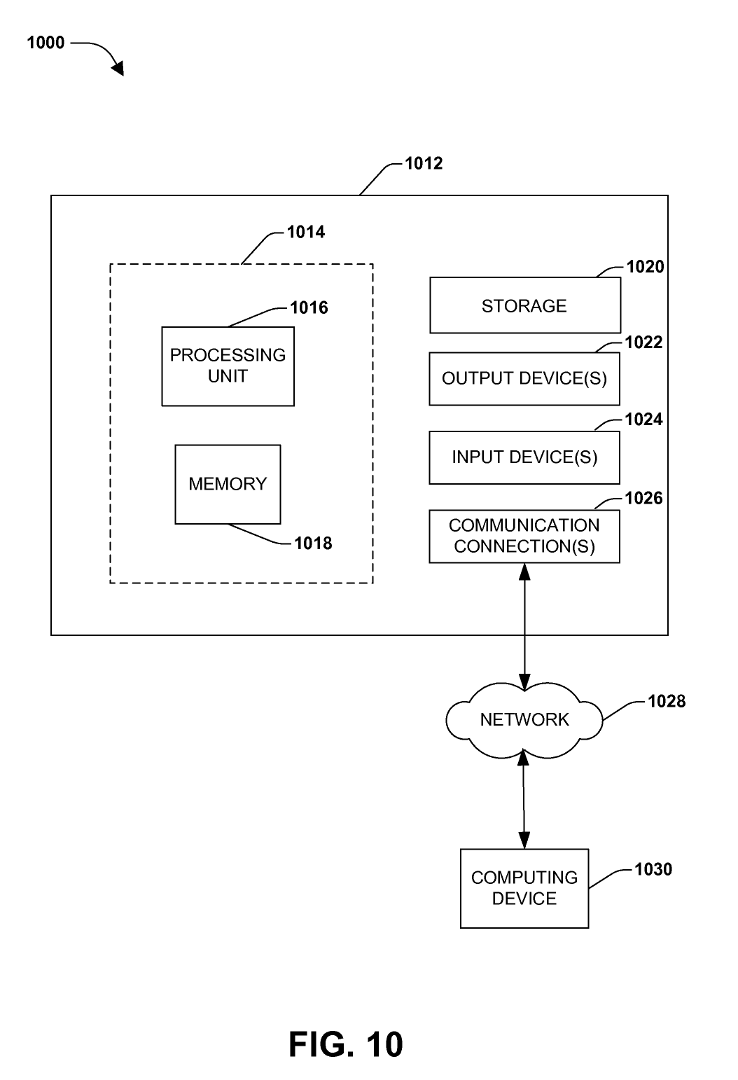

FIG. 10 and the following discussion provide a brief, general description of a suitable computing environment to implement embodiments of one or more of the provisions set forth herein. The operating environment of FIG. 10 is only one example of a suitable operating environment and is not intended to suggest any limitation as to the scope of use or functionality of the operating environment. Example computing devices include, but are not limited to, personal computers, server computers, hand-held or laptop devices, mobile devices (such as mobile phones, Personal Digital Assistants (PDAs), media players, and the like), multiprocessor systems, consumer electronics, mini computers, mainframe computers, distributed computing environments that include any of the above systems or devices, and the like.

Although not required, embodiments are described in the general context of “computer readable instructions” being executed by one or more computing devices. Computer readable instructions may be distributed via computer readable media (discussed below). Computer readable instructions may be implemented as program modules, such as functions, objects, Application Programming Interfaces (APIs), data structures, and the like, that perform particular tasks or implement particular abstract data types. Typically, the functionality of the computer readable instructions may be combined or distributed as desired in various environments.

FIG. 10 illustrates an example of a system 1010 comprising a computing device 1012 configured to implement one or more embodiments provided herein. In one configuration, computing device 1012 includes at least one processing unit 1016 and memory 1018. Depending on the exact configuration and type of computing device, memory 1018 may be volatile (such as RAM, for example), non-volatile (such as ROM, flash memory, etc., for example) or some combination of the two. This configuration is illustrated in FIG. 10 by dashed line 1014.

In other embodiments, device 1012 may include additional features and/or functionality. For example, device 1012 may also include additional storage (e.g., removable and/or non-removable) including, but not limited to, magnetic storage, optical storage, and the like. Such additional storage is illustrated in FIG. 10 by storage 1020. In one embodiment, computer readable instructions to implement one or more embodiments provided herein may be in storage 1020. Storage 1020 may also store other computer readable instructions to implement an operating system, an application program, and the like. Computer readable instructions may be loaded in memory 1018 for execution by processing unit 1016, for example.

The term “computer readable media” as used herein includes computer storage media. Computer storage media includes volatile and nonvolatile, removable and non-removable media implemented in any method or technology for storage of information such as computer readable instructions or other data. Memory 1018 and storage 1020 are examples of computer storage media. Computer storage media includes, but is not limited to, RAM, ROM, EEPROM, flash memory or other memory technology, CD-ROM, Digital Versatile Disks (DVDs) or other optical storage, magnetic cassettes, magnetic tape, magnetic disk storage or other magnetic storage devices, or any other medium which can be used to store the desired information and which can be accessed by device 1012. Any such computer storage media may be part of device 1012.

Device 1012 may also include communication connection(s) 1026 that allows device 1012 to communicate with other devices. Communication connection(s) 1026 may include, but is not limited to, a modem, a Network Interface Card (NIC), an integrated network interface, a radio frequency transmitter/receiver, an infrared port, a USB connection, or other interfaces for connecting computing device 1012 to other computing devices. Communication connection(s) 1026 may include a wired connection or a wireless connection. Communication connection(s) 1026 may transmit and/or receive communication media.

The term “computer readable media” may include communication media. Communication media typically embodies computer readable instructions or other data in a “modulated data signal” such as a carrier wave or other transport mechanism and includes any information delivery media. The term “modulated data signal” may include a signal that has one or more of its characteristics set or changed in such a manner as to encode information in the signal.

Device 1012 may include input device(s) 1024 such as keyboard, mouse, pen, voice input device, touch input device, infrared cameras, video input devices, and/or any other input device. Output device(s) 1022 such as one or more displays, speakers, printers, and/or any other output device may also be included in device 1012. Input device(s) 1024 and output device(s) 1022 may be connected to device 1012 via a wired connection, wireless connection, or any combination thereof. In one embodiment, an input device or an output device from another computing device may be used as input device(s) 1024 or output device(s) 1022 for computing device 1012.

Components of computing device 1012 may be connected by various interconnects, such as a bus. Such interconnects may include a Peripheral Component Interconnect (PCI), such as PCI Express, a Universal Serial Bus (USB), firewire (IEEE 1394), an optical bus structure, and the like. In another embodiment, components of computing device 1012 may be interconnected by a network. For example, memory 1018 may be comprised of multiple physical memory units located in different physical locations interconnected by a network.

Those skilled in the art will realize that storage devices utilized to store computer readable instructions may be distributed across a network. For example, a computing device 1030 accessible via network 1028 may store computer readable instructions to implement one or more embodiments provided herein. Computing device 1012 may access computing device 1030 and download a part or all of the computer readable instructions for execution. Alternatively, computing device 1012 may download pieces of the computer readable instructions, as needed, or some instructions may be executed at computing device 1012 and some at computing device 1030.

Various operations of embodiments are provided herein. In one embodiment, one or more of the operations described may constitute computer readable instructions stored on one or more computer readable media, which if executed by a computing device, will cause the computing device to perform the operations described. The order in which some or all of the operations are described should not be construed as to imply that these operations are necessarily order dependent. Alternative ordering will be appreciated by one skilled in the art having the benefit of this description. Further, it will be understood that not all operations are necessarily present in each embodiment provided herein.

Moreover, the word “exemplary” is used herein to mean serving as an example, instance, or illustration. Any aspect or design described herein as “exemplary” is not necessarily to be construed as advantageous over other aspects or designs. Rather, use of the word exemplary is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims may generally be construed to mean “one or more” unless specified otherwise or clear from context to be directed to a singular form.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure which performs the function in the herein illustrated exemplary implementations of the disclosure. In addition, while a particular feature of the disclosure may have been disclosed with respect to only one of several implementations, such feature may be combined with one or more other features of the other implementations as may be desired and advantageous for any given or particular application. Furthermore, to the extent that the terms “includes”, “having”, “has”, “with”, or variants thereof are used in either the detailed description or the claims, such terms are intended to be inclusive in a manner similar to the term “comprising.”

What is claimed is:

1. A method for determining user utility for web-based economics, executed via a processor on a computer comprising a memory whereon computer-executable instructions comprising the method are stored, the method comprising:
determining a user benefit metric comprising combining a search-based site (SBS) user experience metric and a content-based site (CBS) user experience metric;
determining a user cost metric comprising combining a SBS cost metric with a CBS cost metric; and
combining the user benefit metric with the user cost metric to determine the user utility for a combination of SBS and one or more CBSs.

2. The method of claim 1, comprising:
determining the SBS user experience metric based on relevance of returned results to a query on a SBS; and
determining the CBS user experience metric based on relevance of content on a CBS directed to from the SBS.

3. The method of claim 1, determining the user benefit metric comprising determining a product of the SBS user experience metric and the CBS user experience metric.

4. The method of claim 1, comprising:
determining the SBS cost metric comprising combining an advertising metric on the SBS with a metric that measures an amount of user attention called for the advertising characteristics on the SBS; and
determining the CBS cost metric comprising combining an advertising metric on the CBS with a metric that measures an amount of user attention called for the advertising characteristics on the CBS.

5. The method of claim 1, combining the user benefit metric with the user cost metric comprising:
subtracting the SBS cost metric from the user benefit metric to produce a result; and
subtracting the CBS cost metric from the result.

6. The method of claim 4, determining an advertising metric comprising determining a desired amount of revenue generated per user for an amount of user attention called for the advertising characteristics.

7. The method of claim 4, comprising adjusting the advertising metric on the SBS to obtain a desired user utility for the combination of the search-based website and the one or more content-based websites.

8. The method of claim 4, comprising adjusting the advertising metric on the CBS to obtain a desired user utility for the combination of the search-based website and the content-based website.

9. The method of claim 4, comprising adjusting the advertising metric on a first CBS to obtain a desired user utility for a combination of the search-based website and one or more second content-based websites.

10. The method of claim 1, comprising adjusting an ordering of one or more content-based websites on the search-based website's display page based on the user utility for the respective content-based websites in combination with the search-based website.

11. The method of claim 1, comprising utilizing desired combinations of one or more of:
SBS user experience metric levels;
CBS user experience metric levels;
SBS cost metric levels; and
CBS cost metric levels;
to provide a desired user utility.

12. The method of claim 11, comprising measuring an effect on users of adjusting the user benefit metric, comprising one or more of:
measuring a weight of the SBS user experience metric, comprising:
setting the SBS user experience metric level; and
one or more of:
determining how many users utilize the SBS and one or CBSs combination at the SBS user experience metric level setting; and
determining which type of users utilize the SBS and one or CBSs combination at the SBS user experience metric level setting; and
measuring a weight of the CBS user experience metric, comprising:
setting the CBS user experience metric level; and
one or more of:
determining how many users utilize the SBS and one or CBSs combination at the CBS user experience metric level setting; and
determining which type of users utilize the SBS and one or CBSs combination at the CBS user experience metric level setting.

13. The method of claim 11, comprising measuring an effect on users of adjusting the user cost metric, comprising one or more of:
measuring a weight of the SBS cost metric, comprising:
setting the SBS cost metric level; and
one or more of:
determining how many users utilize the SBS and one or CBSs combination at the SBS cost metric level setting; and
determining which type of users utilize the SBS and one or CBSs combination at the SBS cost metric level setting; and
measuring a weight of the CBS cost metric, comprising:
setting the CBS cost metric level; and
one or more of:
determining how many users utilize the SBS and one or CBSs combination at the CBS cost metric level setting; and
determining which type of users utilize the SBS and one or CBSs combination at the CBS cost metric level setting.

14. A system for determining user utility for a combination of a search-based website and one or more content-based websites, for web-based economics, comprising:
a user benefit determination component configured to combine a search-based site (SBS) user experience metric and a content-based site (CBS) user experience metric to generate a user benefit metric;
a user cost determination component configured to combine a SBS cost metric with a CBS cost metric to generate a user cost metric; and
a user utility determination component configured to combine the user benefit metric with the user cost metric to generate a user utility metric for the combination of the SBS and the one or more CBSs.

15. The system of claim 14, comprising a user experience determination component configured to:
determine the SBS user experience metric based on relevance of returned results to a query on a SBS; and
determine the CBS user experience metric based on relevance of content on a CBS directed to from the SBS.

16. The system of claim 14, comprising a site cost determination component, configured to:
combine a SBS advertising metric with a SBS user attention metric to generate the SBS cost metric; and
combine a CBS advertising metric with a CBS user attention metric to generate the SBS cost metric.

17. The system of claim 16, comprising an advertising metric determination component configured to determine an advertising metric based on desired amount of revenue generated per user for an amount of user attention called for a measure of advertising characteristics on a web-page.

18. The system of claim 16, comprising an advertising characteristics determination component configured to:
determine an advertising characteristics metric for the SBS by combining an advertising type metric and an advertising amount metric for the search-based website; and
determine an advertising metric for the CBS by combining an advertising type metric and an advertising amount metric for the content-based website.

19. The system of claim 16, comprising a user attention determination component configured to:
determine a user attention metric for the SBS by determining how much a user is distracted by the types and amounts of advertising on the search-based website; and
determine a user attention metric for the CBS by determining how much a user is distracted by the types and amounts of advertising on the content-based website.

20. A method for determining user utility for web-based economics, executed via a processor on a computer comprising a memory whereon computer-executable instructions comprising the method are stored, the method comprising:
determining a user benefit metric comprising calculating a product of:
a search-based site (SBS) user experience metric, comprising relevance of returned results to a query on a SBS; and
a content-based site (CBS) user experience metric, comprising relevance of content on a CBS directed to from the SBS;
determining a user cost metric comprising combining;
a SBS cost metric from the user benefit metric to product a result, where the SBS cost metric comprises a combination of an advertising metric on the SBS, comprising a desired amount of revenue generated per user for an amount of user attention called for the advertising characteristics on the SBS, with a metric that measures an amount of user attention called for the advertising characteristics on the SBS; and
a CBS cost metric from the result, where the CBS cost metric comprises a combination of an advertising metric on the CBS, comprising a desired amount of revenue generated per user for an amount of user attention called for the advertising characteristics on the SBS, with a metric that measures an amount of user attention called for the advertising characteristics on the CBS; and
combining the user benefit metric with the user cost metric to determine the user utility for a combination of SBS and one or more CBSs, comprising:
subtracting the SBS cost metric from the user benefit metric to produce a result; and
subtracting the CBS cost metric from the result.
